(19) United States
(12) Patent Application Publication
(10) Pub. No.: US 2025/0007408 A1
(43) Pub. Date: Jan. 2, 2025

(54) Switching Mode Power Supply with Improved Control Accuracy

(71) Applicant: Chengdu Monolithic Power Systems Co., Ltd., Chengdu (CN)

(72) Inventor: Lei Li, Chengdu, Sichuan (CN)

(21) Appl. No.: 18/758,888

(22) Filed: Jun. 28, 2024

(30) Foreign Application Priority Data
Jun. 29, 2023 (CN) 202310788603.1

(51) Int. Cl. H02M 3/158; H02M 3/157

(52) U.S. Cl. CPC H02M 3/158; H02M 3/157

(57) ABSTRACT

A switching mode power supply with improved control accuracy is discussed. The switching mode power supply adopts a sample and hold circuit to sample and hold a peak information of the current flowing through the power stage. Then a difference between the sample and hold signal and a reference voltage is amplified by an amplifying circuit, to generate an adjust reference signal, which is then be used to control a power switch in the power stage.

### CROSS-REFERENCE TO RELATED APPLICATIONS

This application claims priority to and the benefit of Chinese Patent Application No. 202310788603.1, filed Jun. 29, 2023, which is incorporated herein by reference in its entirety.

### BACKGROUND OF THE INVENTION

Switching mode power supplies are widely used in power conversion applications because of small volume and high conversion efficiency. In the switching mode power supply, the peak current mode (e.g., constant peak current control mode) is a well-known control scheme. The so-called constant peak current control mode is that: when a current flowing through a power stage of the switching mode power supply reaches a constant reference value, the power switches in the power stage are controlled to change the switching state (e.g., from an ON state to an OFF state or from an OFF state to an ON state), to have the current flowing through the power stage start to decrease.

However, the actual peak value of the current is influenced by the switching frequency and the inductor, which leads to an inaccuracy of the control.

### SUMMARY OF THE INVENTION

In accordance with an embodiment of the present invention, a switching mode power supply is discussed. The switching mode power supply comprises a power stage, a sample and hold circuit, an amplifying circuit, a comparing circuit, and a logical circuit. The power stage includes a high side power switch and a low side power switch, configured to be periodically turned on and off, to convert an input voltage to an output voltage. The sample and hold circuit is configured to receive a sense signal indicative of a current flowing through the power stage, and to sample and hold a peak value of the sense signal, to generate a sample and hold signal. The amplifying circuit is configured to amplify a difference between the sample and hold signal and a reference voltage, to generate an adjust reference signal. The comparing circuit is configured to compare the adjust reference signal with the sense signal, to generate a comparison signal. The logical circuit is configured to generate a control signal in response to the comparison signal.

In addition, in accordance with an embodiment of the present invention, a controller of a switching mode power supply with a power stage is discussed. The controller comprises: a sample and hold circuit, an amplifying circuit, a comparing circuit, and a logical circuit. The sample and hold circuit is configured to receive a sense signal indicative of a current flowing through the power stage, and to sample and hold a peak value of the sense signal, to generate a sample and hold signal. The amplifying circuit is configured to generate an adjust reference signal in response to a reference voltage and the sample and hold signal. The comparing circuit is configured to compare the adjust reference signal with the sense signal, to generate a comparison signal. The logical circuit is configured to generate a control signal in response to the comparison signal.

Furthermore, in accordance with an embodiment of the present invention, a switching mode power supply is discussed. The switching mode power supply comprises a power stage, a sample and hold circuit, an amplifying circuit, a comparing circuit, and a logical circuit. The power stage includes at least one power switch, configured to be periodically turned on and off, to convert an input voltage to an output voltage. The sample and hold circuit is configured to receive a sense signal indicative of a current flowing through the power stage, and to sample and hold a peak value of the sense signal, to generate a sample and hold signal. The amplifying circuit is configured to amplify a difference between the sample and hold signal and a reference voltage, to generate an adjust reference signal. The comparing circuit is configured to compare the adjust reference signal with the sense signal, to generate a comparison signal. The logical circuit is configured to generate a control signal in response to the comparison signal.

### BRIEF DESCRIPTION OF DRAWINGS

FIG. 1 schematically shows a switching mode power supply 100 in accordance with an embodiment of the present invention.

FIG. 2 schematically shows a switching mode power supply 200 in accordance with an embodiment of the present invention.

FIG. 3 schematically shows a switching mode power supply 300 in accordance with an embodiment of the present invention.

FIG. 4 schematically shows a switching mode power supply 400 in accordance with an embodiment of the present invention.

FIG. 5 schematically shows a switching mode power supply 500 in accordance with an embodiment of the present invention.

FIG. 6 schematically shows a flowchart 600 of a method used in a switching mode power supply in accordance with an embodiment of the present invention.

### DETAILED DESCRIPTION OF THE INVENTION

Embodiments of circuits for switching mode power supply are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

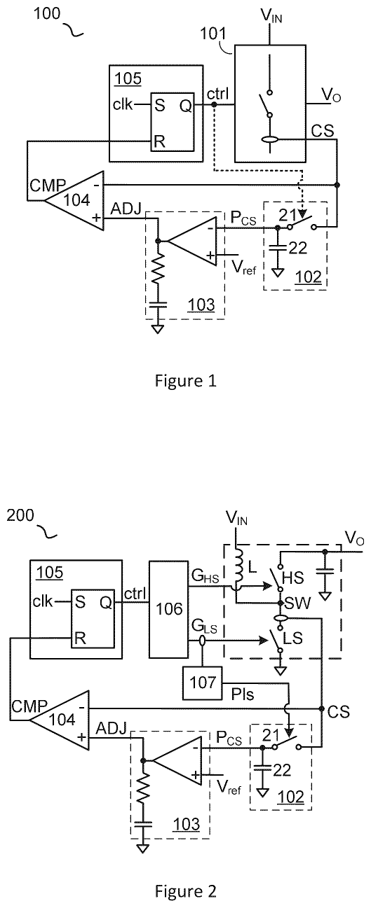

FIG. 1 schematically shows a switching mode power supply 100 in accordance with an embodiment of the present invention. In the example of FIG. 1, the switching mode power supply 100 comprises: a power stage 101 and a controller. The power stage 101 includes at least one power switch, configured to be periodically turned on and off, to convert an input voltage V_{IN} to an output voltage V_{O}. The controller comprises: a sample and hold circuit 102, an amplifying circuit 103, a comparing circuit 104, and a logical circuit 105. The sample and hold circuit 102 is configured to receive a sense signal CS indicative of a current flowing through the power stage 101, and to sample and hold a peak value (i.e., a maximum value) of the sense signal CS, to generate a sample and hold signal P_{CS}. The amplifying circuit 103 is configured to amplify (or amplify and integrate) a difference between the sample and hold signal P_{CS} and a reference voltage V_{ref}, to generate an adjust reference signal ADJ. The comparing circuit 104 is configured to compare the adjust reference signal ADJ with the sense signal CS, to generate a comparison signal CMP. The logical circuit 105 is configured to generate a control signal ctrl in response to the comparison signal CMP, to control the power switch.

In one embodiment of the present invention, the logical circuit 105 comprises a RS flip flop, having a set terminal S, a reset terminal R and an output terminal Q. The set terminal is configured to receive a clock signal clk. The reset terminal is configured to receive the comparison signal CMP. The logical circuit is configured to generate the control signal ctrl at the output terminal Q in response to the clock signal clk and the comparison signal CMP, to change a switching state of the power switch, e.g., to turn on the power switch or to turn off the power switch. Specifically, the logical circuit 105 is configured to have the current flowing through the power stage increase in response to the clock signal clk and have the current flowing through the power stage decrease in response to the comparison signal CMP. In other embodiments of the present invention, the logical circuit 105 may be set by other signals. For example, when the output voltage V_{O} reaches a certain voltage value, the logical circuit 105 is set, and the current flowing through the power stage 101 starts to increase.

In one embodiment of the present invention, the sample and hold circuit 102 comprises: a sample switch 21 and a sample capacitor 22. The sample switch 21 is configured to be turned on under the control of the control signal ctrl when the current flowing through the power stage 101 is going to decrease from its peak value, so that the peak value of the sense signal CS is delivered to the sample capacitor 22. Then the sample switch 21 is turned off, and the peak current information of the current flowing through the power stage 101 is held at the sample capacitor 22. As shown in FIG. 1, the control signal ctrl is delivered to a control terminal of the sample switch 21 (as shown with the dashed line), so as to turn on the sample switch 21 when the current flowing through the power stage reaches the peak current.

In one embodiment of the present invention, the power stage 101 may comprise a boost circuit, as shown in FIG. 2. FIG. 2 schematically shows a switching mode power supply 200 in accordance with an embodiment of the present invention. In the example of FIG. 2, the power stage 101 comprises: a high side power switch HS and a low side power switch LS, coupled between the output voltage V_{O} and a reference ground. An inductor L is coupled between a switch node SW and the input voltage V_{IN}. The switch node is formed by a common connection of the high side power switch HS and the low side power switch LS. The switching mode power supply 200 further comprises: a drive circuit 106, configured to generate a high side drive signal G_{HS} and a low side drive signal G_{LS} in response to the control signal ctrl. As shown in FIG. 2, the switching mode power supply 200 further comprises: a short pulse generator 107, configured to generate a short pulse signal Pls in response to the low side drive signal G_{LS}, to have the sample switch 21 be on for a short time period. In one embodiment of the present invention, the short pulse generator 107 is configured to generate the short pulse signal Pls in response to an edge jump (e.g., a falling edge jump) of the low side drive signal G_{LS}. The edge jump may refer to a logical change of the signal. For example, the falling edge jump may refer to a change from a logical high state to a logical low state; and a rising edge jump may refer to a change from a logical low state to a logical high state.

During the operation of the switching mode power supply 200, when the low side power switch LS is ON, the input voltage V_{IN}, the inductor L, and the low side power switch LS form a current loop. The inductor current increases, i.e. the current flowing through the power stage 101 increases. When the low side power switch LS is going to be turned off, the current flowing through the power stage 101 reaches its maximum value (i.e., peak current). The short pulse generator 107 detects the falling edge of low side drive signal G_{LS} and turns on the sample switch 21 accordingly. Then the peak current information is delivered to the sample capacitor 22. Due to an influence of the parasitic parameters in actual circuits, there is a time delay at the delivery of the low side drive signal G_{LS} from the drive circuit 106 to the low side power switch LS. During this delay time period, the low side power switch LS is going to be turned off but has not been turned off yet, and the sample switch 21 is turned on to sample and hold the peak current, which is then delivered to the amplifying circuit 103.

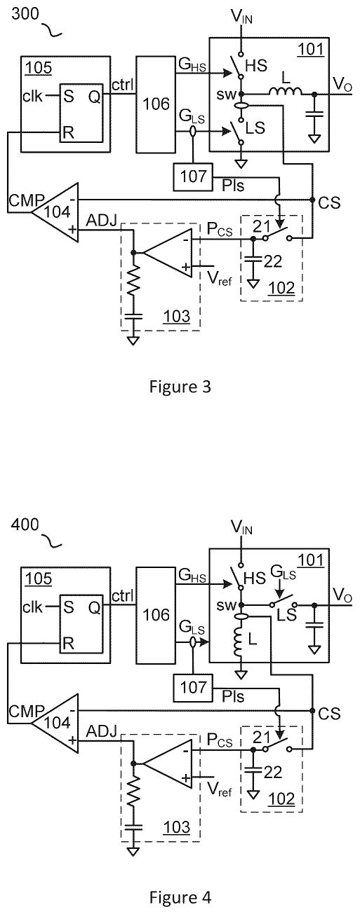

In one embodiment of the present invention, the power stage 101 may comprise a buck circuit, as shown in FIG. 3. FIG. 3 schematically shows a switching mode power supply 300 in accordance with an embodiment of the present invention. In the example of FIG. 3, the power stage 101 comprises: a high side power switch HS and a low side power switch LS, coupled between the input voltage V_{IN} and the reference ground. An inductor L is coupled between a switch node SW and the output voltage V_{O}. The switch node SW is formed by a common connection of the high side power switch HS and the low side power switch LS. The switching mode power supply 300 further comprises: a drive circuit 106, configured to generate a high side drive signal G_{HS} and a low side drive signal G_{LS} in response to the control signal ctrl. As shown in FIG. 3, the switching mode power supply 300 further comprises: a short pulse generator 107, configured to generate a short pulse signal Pls in response to an edge jump (e.g., a rising edge jump) of the low side drive signal G_{LS}, to have the sample switch 21 be on for a short time period.

During the operation of the switching mode power supply 300, when the high side power switch HS is ON, the input voltage V_{IN} is converted to the output voltage V_{O} by way of the inductor L and the high side power switch HS. The inductor current increases, i.e. the current flowing through the power stage 101 increases. When the high side power switch HS is going to be turned off, and the low side power switch LS is going to be turned on, the current flowing through the power stage 101 reaches its maximum value (i.e., peak current). At the sample and hold circuit 102, the sample switch 21 is turned on in response to the rising edge of the low side drive signal G_{LS}, to deliver the peak current information of the current flowing through the power stage 101 to the sample capacitor 22. Due to an influence of the parasitic parameters in actual circuits, there is a time delay at the delivery of the low side drive signal G_{LS} from the drive circuit 106 to the low side power switch LS. During this delay time period, the low side power switch LS is going to be turned on but has not been turned on yet, and the sample switch 21 is turned on to sample and hold the peak current, which is delivered to the amplifying circuit 103.

In the examples of FIG. 2 and FIG. 3, the short pulse generator 107 generates the short pulse signal Pls in response to the edge jump of the low side drive signal G_{LS}. However, one skilled in the art should realize that the sample switch may be turned on in response to the edge jump of the high side drive signal GHS.

The embodiments in the FIG. 2 and FIG. 3 respectively shows the power stage including a buck circuit and a boost circuit. However, one skilled in the art should realize that the power stage may comprise other topologies, such as buck-boost circuit, flyback circuit, forward circuit, etc. The following text would be illustrated with reference to the example that the power stage includes a buck-boost circuit.

FIG. 4 schematically shows a switching mode power supply 400 in accordance with an embodiment of the present invention. In the example of FIG. 4, the power stage 101 comprises: a high side power switch HS and a low side power switch LS, coupled between the input voltage V_{IN} and the output voltage V_{O}. An inductor L is coupled between a switch node SW and a reference ground. The switch node SW is formed by a common connection of the high side power switch HS and the low side power switch LS. The switching mode power supply 400 further comprises: a drive circuit 106, configured to generate a high side drive signal G_{HS} and a low side drive signal G_{LS} in response to the control signal ctrl. When the low side power switch LS is going to be turned off (e.g., when the low side drive signal G_{LS} is turning to high from low), the sample switch 21 is turned on. Accordingly, the sample and hold circuit 102 samples and holds the current flowing through the power stage, to generate the sample and hold signal P_{CS}. As shown in FIG. 4, the switching mode power supply 400 further comprises: a short pulse generator 107, configured to generate a short pulse signal Pls in response to an edge jump (e.g., a falling edge jump) of the low side drive signal G_{LS}, to have the sample switch 21 be on for a short time period.

During the operation of the switching mode power supply 400, when the high side power switch HS is ON, the input voltage V_{IN}, the high side power switch HS, and the inductor L form a current loop. The inductor current increases, so does the current flowing through the power stage 101 increases. When the high side power switch HS is going to be turned off, and the low side power switch LS is going to be turned on, the current flowing through the power stage 101 reaches its maximum value (i.e., peak current). At the sample and hold circuit 102, the sample switch 21 is turned on in response to the rising edge of the low side drive signal G_{LS}, to deliver the peak current information of the current flowing through the power stage 101 to the sample capacitor 22. Due to an influence of the parasitic parameters in actual circuits, there is a time delay at the delivery of the low side drive signal G_{LS} from the drive circuit 106 to the low side power switch LS. During this delay time period, the low side power switch LS is going to be turned on but has not been turned on yet, and the sample switch 21 is turned on to sample and hold the peak current, which is delivered to the amplifying circuit 103.

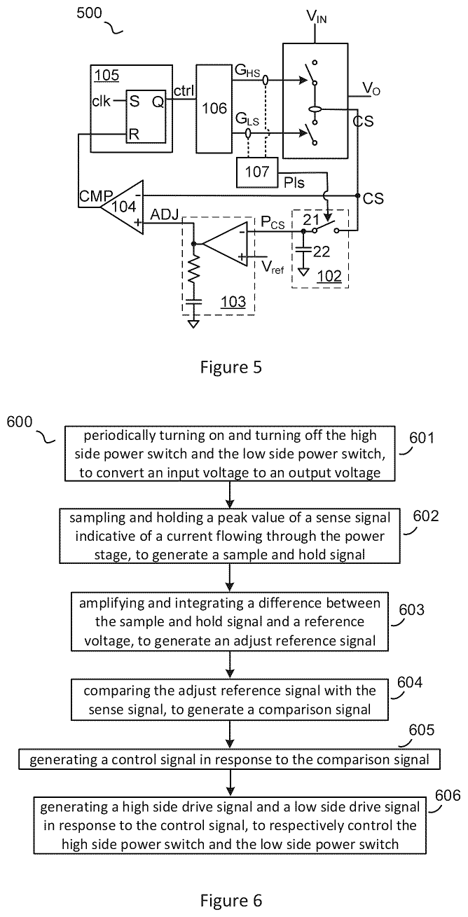

FIG. 5 schematically shows a switching mode power supply 500 in accordance with an embodiment of the present invention. In the example of FIG. 5, the switching mode power supply 500 comprises: a power stage 101, including a high side power switch HS and a low side power switch LS, configured to be periodically turned on and off, to convert an input voltage V_{IN} to an output voltage V_{O}. The switching mode power supply 500 further comprises: a sample and hold circuit 102, an amplifying circuit 103, a comparing circuit 104, a logical circuit 105, a drive circuit 106, and a short pulse generator 107. The sample and hold circuit 102 is configured to receive a sense signal CS indicative of a current flowing through the power stage 101, and to sample and hold a peak value (i.e., a maximum value) of the sense signal CS, to generate a sample and hold signal P_{CS}. The amplifying circuit 103 is configured to amplify a difference between the sample and hold signal P_{CS} and a reference voltage V_{ref}, to generate an adjust reference signal ADJ. The comparing circuit 104 is configured to compare the adjust reference signal ADJ with the sense signal CS, to generate a comparison signal CMP. The logical circuit 105 is configured to generate a control signal ctrl in response to the comparison signal CMP. The drive signal 106 is configured to generate a high side drive signal G_{HS} and a low side drive signal G_{LS} in response to the control signal ctrl, to respectively control the high side power switch HS and the low side power switch LS. The short pulse generator 107 is configured to generate a short pulse signal Pls in response to an edge jump of the high side drive signal G_{HS} or an edge jump of the low side drive signal G_{LS}, to control the sample and hold circuit 102 to sample and hold the peak value of the sense signal CS.

In one embodiment of the present invention, the amplifying circuit 102 comprises: an error amplifier and a compensation loop, to amplify the difference between the sample and hold signal P_{CS} and the reference voltage V_{ref}, to generate the adjust reference signal ADJ. In one embodiment of the present invention, the compensation loop comprises a resistor and a capacitor.

FIG. 6 schematically shows a flowchart 600 of a method used in a switching mode power supply in accordance with an embodiment of the present invention. The switching mode power supply comprises a power stage having a high side power switch and a low side power switch. The method comprises:

Step 601, periodically turning on and turning off the high side power switch and the low side power switch, to convert an input voltage to an output voltage.

Step 602, sampling and holding a peak value of a sense signal indicative of a current flowing through the power stage, to generate a sample and hold signal.

Step 603, amplifying and integrating a difference between the sample and hold signal and a reference voltage, to generate an adjust reference signal.

Step 604, comparing the adjust reference signal with the sense signal, to generate a comparison signal.

Step 605, generating a control signal in response to the comparison signal.

And

Step 606, generating a high side drive signal and a low side drive signal in response to the control signal, to respectively control the high side power switch and the low side power switch.

In one embodiment of the present invention, the method further comprises: generating a short pulse signal in response to the high side drive signal (e.g., an edge jump of the high side drive signal) or in response to the low side drive signal (e.g., an edge jump of the low side drive signal), to sample and hold the peak value of the sense signal.

In one embodiment of the present invention, the method further comprises: providing a clock signal, wherein the control signal is generated in response to the clock signal and the comparison signal.

Several embodiments of the foregoing switching mode power supply amplify (or amplify and integrate) the difference between the peak current and the reference voltage, to adjust the actual reference voltage. Thus, the accuracy of the control is improved.

It is to be understood in these letters patent that the meaning of “A” is coupled to “B” is that either A and B are connected to each other as described below, or that, although A and B may not be connected to each other as described above, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

1. A switching mode power supply, comprising:
a power stage, including a high side power switch and a low side power switch, configured to be periodically turned on and off, to convert an input voltage to an output voltage;
a sample and hold circuit, configured to receive a sense signal indicative of a current flowing through the power stage, and to sample and hold a peak value of the sense signal, to generate a sample and hold signal;
an amplifying circuit, configured to amplify a difference between the sample and hold signal and a reference voltage, to generate an adjust reference signal;
a comparing circuit, configured to compare the adjust reference signal with the sense signal, to generate a comparison signal; and
a logical circuit, configured to generate a control signal in response to the comparison signal.

2. The switching mode power supply of claim 1, wherein the sample and hold circuit comprises:
a sample switch and a sample capacitor, wherein the sample switch is configured to be turned on when the current flowing through the power stage is going to decrease from its peak value, so that the peak value of the sense signal is delivered to the sample capacitor.

3. The switching mode power supply of claim 1, wherein:
the logical circuit is configured to generate the control signal in response to the comparison signal and a clock signal, wherein the logical circuit is configured to generate the control signal to control the current flowing through the power stage to increase in response to the clock signal, and is configured to generate the control signal to control the current flowing through the power stage to decrease in response to the comparison signal.

4. The switching mode power supply of claim 1, further comprising:
a driver, configured to generate a high side drive signal and a low side drive signal in response to the control signal, to respectively control the high side power switch and the low side power switch.

5. The switching mode power supply of claim 4, further comprising:
a short pulse generator, configured to generate a short pulse signal in response to the low side drive signal or the high side drive signal, to control the sample and hold circuit to sample and hold the peak value of the sense signal.

6. The switching mode power supply of claim 5, wherein:
the short pulse generator is configured to generate the short pulse signal in response to an edge jump of the low side drive signal or an edge jump the high side drive signal.

7. A controller of a switching mode power supply with a power stage, comprising:
a sample and hold circuit, configured to receive a sense signal indicative of a current flowing through the power stage, and to sample and hold a peak value of the sense signal, to generate a sample and hold signal;
an amplifying circuit, configured to generate an adjust reference signal in response to a reference voltage and the sample and hold signal;
a comparing circuit, configured to compare the adjust reference signal with the sense signal, to generate a comparison signal; and
a logical circuit, configured to generate a control signal in response to the comparison signal.

8. The controller of claim 7, wherein the sample and hold circuit comprises:
a sample switch and a sample capacitor, wherein the sample switch is configured to be turned on when the current flowing through the power stage is going to decrease from its peak value, so that the peak value of the sense signal is delivered to the sample capacitor.

9. The controller of claim 7, wherein:
the logical circuit is configured to generate the control signal in response to the comparison signal and a clock signal, wherein the logical circuit is configured to generate the control signal to control the current flowing through the power stage to increase in response to the clock signal, and is configured to generate the control signal to control the current flowing through the power stage to decrease in response to the comparison signal.

10. A switching mode power supply, comprising:
a power stage, including at least one power switch, configured to be periodically turned on and off, to convert an input voltage to an output voltage;
a sample and hold circuit, configured to receive a sense signal indicative of a current flowing through the power stage, and to sample and hold a peak value of the sense signal, to generate a sample and hold signal;
an amplifying circuit, configured to amplify a difference between the sample and hold signal and a reference voltage, to generate an adjust reference signal;
a comparing circuit, configured to compare the adjust reference signal with the sense signal, to generate a comparison signal; and
a logical circuit, configured to generate a control signal in response to the comparison signal.

11. The switching mode power supply of claim 10, wherein the sample and hold circuit comprises:
a sample switch and a sample capacitor, wherein the sample switch is configured to be turned on when the current flowing through the power stage is going to decrease from its peak value, so that the peak value of the sense signal is delivered to the sample capacitor.

12. The switching mode power supply of claim 10, wherein:
the logical circuit is configured to generate the control signal in response to the comparison signal and a clock signal, wherein the logical circuit is configured to generate the control signal to control the current flowing through the power stage to increase in response to the clock signal, and is configured to generate the control signal to control the current flowing through the power stage to decrease in response to the comparison signal.

13. The switching mode power supply of claim 10, wherein the power switch comprises a first power switch and a second power switch, and wherein the switching mode power supply further comprising:
a drive circuit, configured to generate a first drive signal and a second drive signal in response to the control signal, to respectively control the first power switch and the second power switch.

14. The switching mode power supply of claim 13, further comprising:
a short pulse generator, configured to generate a short pulse signal in response to the low side drive signal or the high side drive signal, to control the sample and hold circuit to sample and hold the peak value of the sense signal.

15. The switching mode power supply of claim 14, wherein:
the short pulse generator is configured to generate the short pulse signal in response to an edge jump of the low side drive signal or an edge jump the high side drive signal.
